(19) United States
(12) Patent Application Publication
(10) Pub. No.: US 2025/0050828 A1
(43) Pub. Date: Feb. 13, 2025

(54) TRANSFER DEVICE

(71) Applicant: HITACHI ASTEMO, LTD., Hitachinaka-shi, Ibaraki (JP)

(72) Inventors: Nobuhiro ARIYASU, Chiyoda-ku, Tokyo (JP); Shuhei KANEKO, Chiyoda-ku, Tokyo (JP); Nobuyoshi MORITA, Chiyoda-ku, Tokyo (JP); Mikio KATAOKA, Chiyoda-ku, Tokyo (JP); Wataru IBA, Chiyoda-ku, Tokyo (JP); Teruaki NOMURA, Chiyoda-ku, Tokyo (JP)

(73) Assignee: HITACHI ASTEMO, LTD., Hitachinaka-shi, Ibaraki (JP)

(21) Appl. No.: 18/718,889

(22) PCT Filed: Aug. 12, 2022
(86) PCT No.: PCT/JP2022/030761

§ 371 Date: Jun. 12, 2024

(30) Foreign Application Priority Data
Dec. 23, 2021 (JP) 2021-209049

(51) Int. Cl. B60R 16/023; G07C 5/00; G07C 5/08

(52) U.S. Cl. CPC B60R 16/0232; G07C 5/008; G07C 5/0808

(57) ABSTRACT

Provided is a transfer device capable of suppressing shortage of memory resources even when the transfer device receives a diagnosis request from an external diagnostic equipment with respect to a plurality of electronic devices. A transfer device 20 receives a diagnosis request that is a message from an external diagnostic equipment 10 to a plurality of ECUs 18 from the external diagnostic equipment 10, and transfers the diagnosis request to some ECUs 18 out of a plurality of ECUs 18. Then, the transfer device 20 receives a diagnosis response that is a message from the ECU18 to the external diagnostic equipment 10 from some ECUs 18, transfers the diagnosis response to the external diagnostic equipment 10 and, thereafter, transfers the diagnosis request to ECUs 18 different from the above-mentioned some ECUs 18.

### TECHNICAL FIELD

The present invention relates to a transfer device.

### BACKGROUND ART

In recent years, in addition to the increase of the number of electronic control units (ECUs) mounted on a vehicle, with increase of the number of functions and a storage capacity of each ECU, the increase of an amount of data transacted between a vehicle and an external diagnostic equipment is expected. In order to perform diagnosis communication more efficiently, there has been studied diagnosis communication that conforms to diagnostics over Internet protocol (DoIP), which is a diagnosis communication standard that uses Internet protocol.

Patent literature 1 discloses a diagnosis communication technique in accordance with DoIP. The technology disclosed in Patent Literature 1 provides a vehicle communication control device capable of avoiding the occurrence of operation interference of an ECU due to messages from a plurality of external tools connected to a network outside a vehicle.

### CITATION LIST

### Patent Literatures

PTL 1: Japanese Patent Application Laid-Open No. 2013-123998

### SUMMARY OF INVENTION

### Technical Problem

The diagnosis communication network that conforms to DoIP includes: an IP network outside the vehicle; and an in-vehicle network (LAN). An external diagnostic equipment that is connected to an IP network outside the vehicle performs diagnosis communication with an ECU that is connected to an in-vehicle network. For example, Ethernet (registered trademark) is often used as the IP network outside the vehicle. As the in-vehicle network, a network that conforms to a communication protocol such as CAN, CANFD or the like is often used. Accordingly, in the diagnosis communication network system that conforms to DoIP, it is often the case that a transfer device that converts a diagnosis request, which is a message stored in an Ethernet frame transmitted from an external diagnostic equipment into a protocol, and transfers the protocol to the ECU. When the transfer device receives a diagnosis response that is a message from the ECU after transferring a diagnosis request from the external diagnostic equipment to the ECU, the transfer device performs protocol conversion of the diagnosis response, and transfers the diagnosis response to the external diagnostic equipment. Accordingly, the transfer device needs to secure a buffer area for temporarily storing the diagnosis response.

In the diagnosis communication network system that conforms to DoIP, there is a case where the external diagnostic equipment simultaneously transmits a diagnosis request to a plurality of ECUs that are targets to be diagnosed. In this case, the transfer device can simultaneously receive diagnosis responses from a plurality of ECUs, it is necessary to ensure a buffer area that can cover the number of ECUs having a possibility of becoming targets to be diagnosed. In this case, there arises a problem that a memory use amount of the transfer device is increased so that an amount of a memory resource becomes short. The technique disclosed in Patent Literature 1 does not take into account such a problem at all and hence, there is room for improvement.

The present invention has been made in view of the above-mentioned circumstance, and it is an object of the present invention is to provide a transfer device capable of suppressing shortage of memory resources even when the transfer device receives a diagnosis request for a plurality of electronic devices from an external diagnostic equipment.

### Solution to Problem

To overcome the above-mentioned problem, a transfer device according to the present invention is a transfer device that transfers a message from one side to the other side between a plurality of electronic devices mounted on a vehicle and an external diagnostic equipment, wherein the transfer device is configured such that: the transfer device receives a diagnosis request that is a message from the external diagnostic equipment to the plurality of electronic devices, and transfers the diagnosis request to some electronic devices out of the plurality of electronic devices; and the transfer device receives a diagnosis response that is a message from the electronic devices to the external diagnostic equipment from the some electronic devices and transfers the diagnosis response to the external diagnostic device and, thereafter, transfers the diagnosis request to another electronic devices different from the some electronic devices.

### Advantageous Effects of Invention

According to the present invention, it is possible to provide a transfer device capable of suppressing shortage of memory resources even when the transfer device receives diagnosis requests for a plurality of electronic devices from an external diagnostic equipment.

Problems, configurations, and effects other than the above will be clarified by the description of the following embodiments.

### BRIEF DESCRIPTION OF DRAWINGS

FIG. 1 is a diagram illustrating the configuration of a diagnosis communication network system that conforms to DoIP.

FIG. 2 is a view illustrating the functional configuration of a transfer device.

FIG. 3 is a diagram illustrating one example of a table for managing a progress state of a diagnosis.

FIG. 4 is a sequence diagram illustrating an outline of operations of respective components of the transfer device.

FIG. 5 is a flowchart illustrating processing performed by the transfer device when the transfer device receives a diagnosis request from an external diagnostic equipment.

FIG. 6 is a flowchart illustrating processing performed by the transfer device when the transfer device receives a diagnosis response from an ECU.

FIG. 7 is a flowchart illustrating processing performed by the transfer device when the transfer device transfers the diagnosis response to the external diagnostic equipment.

### DESCRIPTION OF EMBODIMENTS

Hereinafter, embodiments of the present invention will be described with reference to the drawings. With respect to the configurations that are denoted by the same reference numerals in the respective embodiments, these configurations have substantially the same functions in the respective embodiments unless otherwise specified. In such a case, the description of the configurations will be omitted.

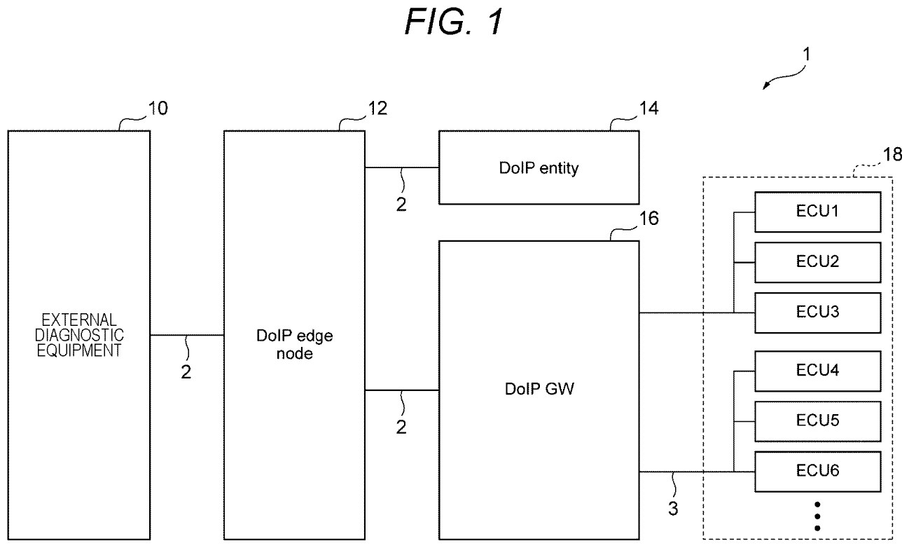

FIG. 1 is a diagram illustrating the configuration of a diagnosis communication network system 1 that conforms to DOIP.

The diagnosis communication network system 1 that conforms to DoIP includes: an external diagnostic equipment 10; a DoIP edge node 12; a DoIP entity 14; a DoIP gateway 16; and a plurality of ECUs 18 that are targets to be diagnosed.

The external diagnostic equipment 10 and the DoIP edge node 12 are connected to each other via a DoIP network 2. The DoIP edge node 12 and both of the DoIP entity 14 and the DoIP gateway 16 are connected to each other via the DoIP network 2. The DoIP gateway 16 and a plurality of ECUs 18 are connected to each other via an in-vehicle network 3.

The DoIP gateway 16 may be incorporated in the DoIP edge node 12. In this case, the DoIP edge node 12 is connected to a plurality of respective ECUs 18 via the in-vehicle network 3. The ECU18 is an example of an “electronic device” of the present invention.

The DoIP network 2 may be, for example, Ethernet. The in-vehicle network 3 may be, for example, a local area network (LAN) that conforms to a communication protocol such as CAN or CANFD. In the present embodiment, the description will be made assuming that the DoIP network 2 is Ethernet and the in-vehicle network 3 is a LAN that conforms to CAN.

The external diagnostic equipment 10 transmits a diagnosis request to the ECU18 that is a target to be diagnosed. The diagnosis request is a message instructing performing of diagnosis processing to the diagnosis target ECU 18 that is a target to be diagnosed. The diagnosis request is generated in accordance with DoIP stipulated in ISO 13400, and an identifier for designating the ECU 18 that is a target to be diagnosed is incorporated in the diagnosis request. With respect to the identifier, there exist two types of identifiers, that is, an identifier that designates one ECU 18 as a target to be diagnosed (hereinafter, also referred to as a “physical address”), and an identifier that designates a plurality of ECUs 18 as targets to be diagnosed (hereinafter, also referred to as “function addresses”).

The DoIP edge node 12 is an ECU that is directly connected to the external diagnostic equipment 10. The DoIP edge node 12 transfers the diagnosis request that is transmitted from the external diagnostic equipment 10 to the DoIP entity 14 or the DoIP gateway 16 in accordance with the DoIP. The DoIP edge node 12 transfers, in accordance with the DoIP, the diagnosis response that corresponds to the diagnosis request that is transmitted from the DoIP entity 14 or the DoIP gateway 16 to the external diagnostic equipment 10. The diagnosis response is a message that includes a result of the diagnostic processing executed in response to the diagnosis request.

The DoIP entity 14 is an ECU that is a target to be diagnosed that is directly connected to the DoIP edge node 12. The DoIP entity 14, in accordance with the DoIP, receives a diagnosis request from the DoIP edge node 12, and transmits a diagnosis response to the DoIP edge node 12.

The DoIP gateway 16 receives the diagnosis request that is transferred from the DoIP edge node 12, and temporarily stores the diagnosis request in the buffer area. The DoIP gateway 16 converts the diagnosis request stored in the buffer area into a format of a CAN protocol and transfers the CAN protocol to the diagnosis target ECU18. The DoIP gateway 16 receives the diagnosis response that is transmitted from the ECU18 that is a target to be diagnosed, and temporarily stores the diagnosis response in the buffer area. The DoIP gateway 16 converts the diagnosis response stored in the buffer area into a DoIP format and transfers the DoIP format to the external diagnostic equipment 10 via the DoIP edge node 12.

In a case where the DoIP gateway 16 is incorporated in the DoIP edge node 12, the DoIP edge node 12 performs the above-described protocol conversion, and the transfer of a diagnosis request and a diagnosis response is performed between the external diagnostic equipment 10 and the ECU 18 that is a target to be diagnosed.

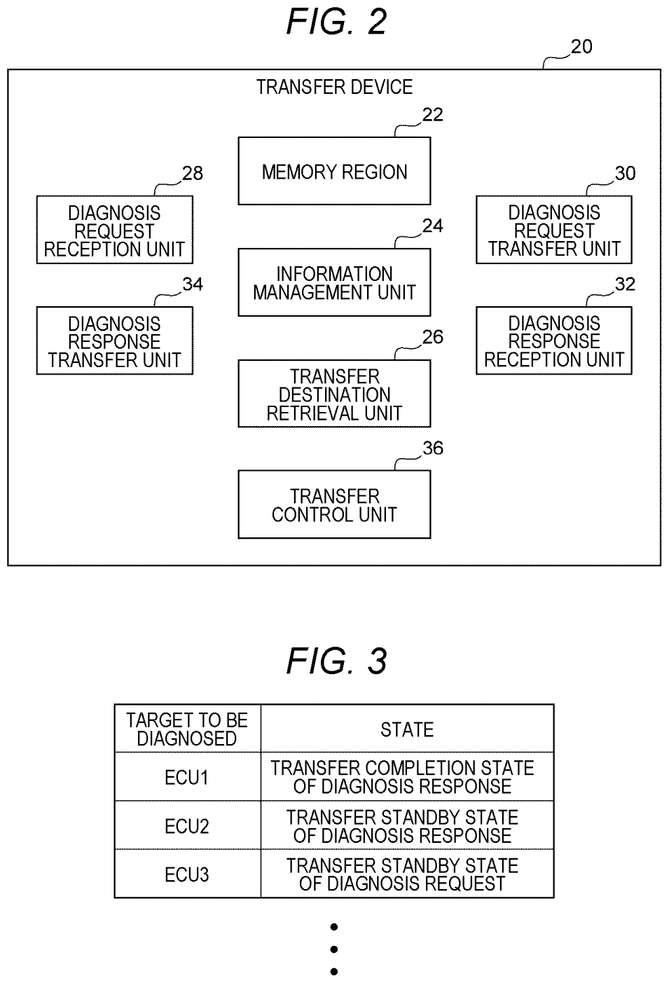

FIG. 2 is a view illustrating the functional configuration of a transfer device 20.

The transfer device 20 is a device that transfers a message between the plurality of ECUs 18 mounted on the vehicle and the external diagnostic equipment 10. That is the transfer device 20 transfers the message from the plurality of ECUs 18 to the external diagnostic equipment 10 and from the external diagnostic equipment 10 to the plurality of ECUs 18. The transfer device 20 of the present embodiment is an ECU that transfers a diagnosis request and a diagnosis response between the plurality of ECUs 18 that are targets to be diagnosed and the external diagnostic equipment 10. The transfer device 20 is constituted of the DoIP gateway 16 or the DoIP edge node 12 illustrated in FIG. 1.

The transfer device 20 includes a storage area 22 which is a buffer area for temporarily storing a diagnosis request and a diagnosis response. The transfer device 20 includes: a diagnosis request reception unit 28 that receives the diagnosis request transmitted from the external diagnostic equipment 10; and a diagnosis request transfer unit 30 that performs protocol conversion of the diagnosis request and transfers the protocol to the ECU18. The transfer device 20 includes: a diagnosis response reception unit 32 that receives a diagnosis response transmitted from ECU18; and a diagnosis response transfer unit 34 that performs the protocol conversion of the diagnosis response and transfers the protocol to the external diagnostic equipment 10.

Further, the transfer device 20 includes: a transfer destination retrieval unit 26 that retrieves a transfer destination of a diagnosis request based on an identifier included in the diagnosis request transmitted from the external diagnostic equipment 10; an information management unit 24 that manages a progress state of a diagnosis; and a transfer control unit 36 that controls the transfer of the diagnosis request and a diagnosis response based on the progress state that the information management unit 24 manages.

FIG. 3 is a diagram illustrating one example of a table for managing a progress state of a diagnosis.

The information management unit 24 may, using a table as illustrated in FIG. 3 manage the progress states of the diagnosis of the respective ECUs 18 that are targets to be diagnosed. The information management unit 24 may update the information indicating the progress state of the diagnosis each time the reception status or the transfer status of the diagnosis request or the diagnosis response changes in the transfer device 20. Examples of the information that indicates the progress state of the diagnosis include: a reception standby state of a diagnosis request; a receiving state of the diagnosis request; a transfer standby state of the diagnosis request; a transferring state of the diagnosis request; a reception standby state of the diagnosis response; a receiving state of the diagnosis response; a transferring standby state of the diagnosis response; a transferring state of the diagnosis response; and a transferring completion state of the diagnosis response. The transfer device 20 may have the configuration other than the configuration illustrated in FIG. 2.

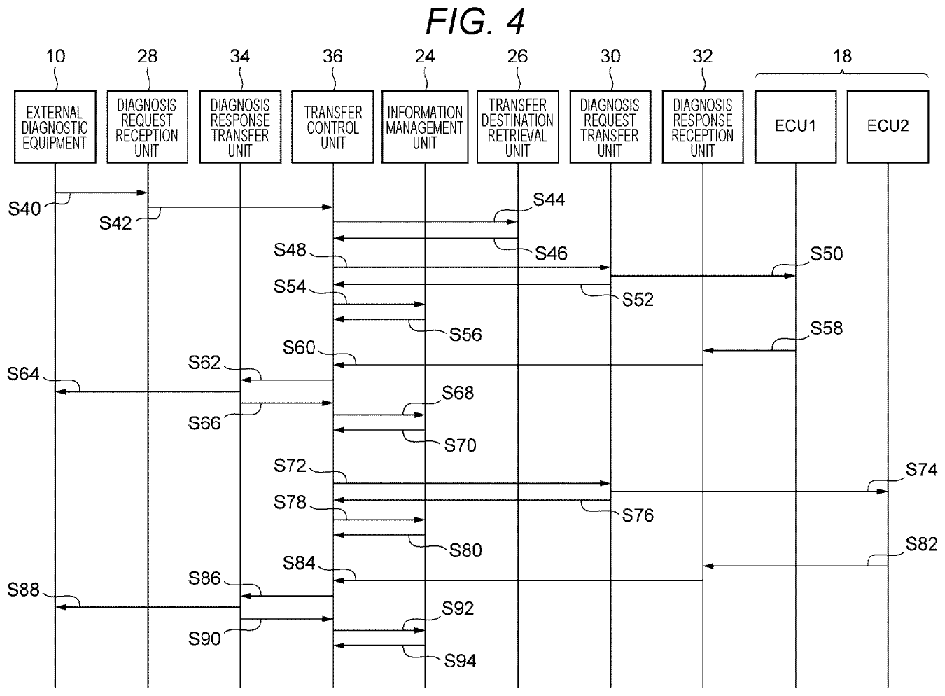

FIG. 4 is a sequence diagram illustrating an outline of operations of respective components of the transfer device 20. In FIG. 4, a case is described where a plurality of ECUs 18 that are targets to be diagnosed are designated by a plurality of physical addresses or functional addresses, and the external diagnostic equipment 10 transmits a diagnosis request to the plurality of ECUs 18.

In step S40, the diagnosis request reception unit 28 receives the diagnosis request to the plurality of ECUs 18 from the external diagnostic equipment 10. In such processing, it is assumed that the diagnosis request reception unit 28 receives the diagnosis request to the ECU1 and ECU2 that are targets to be diagnosed as the diagnosis request to the plurality of ECUs 18.

In step S42, the diagnosis request reception unit 28 notifies the transfer control unit 36 of the reception of the diagnosis request.

In step S44, the transfer control unit 36 instructs the transfer destination retrieval unit 26 to retrieve respective transfer destination of the diagnosis request to the plurality of ECUs 18.

In step S46, the transfer destination retrieval unit 26 retrieve the respective transfer destinations of the diagnosis request to the plurality of ECUs 18, and notifies the transfer control unit 36 of the respective transfer destinations.

In step S48, the transfer control unit 36 instructs the diagnosis request transfer unit 30 to transfer the diagnosis request to some of the plurality of ECUs 18. In this processing, it is assumed that the transfer control unit 36 instructs the diagnosis request transfer unit 30 to transfer the diagnosis request to the ECU1.

In step S50, the diagnosis request transfer unit 30 transfers the diagnosis request to the ECU18 instructed by the transfer control unit 36. In this processing, the diagnosis request transfer unit 30 transfers the diagnosis request to the ECU1.

In step S52, when the transfer of the diagnosis request is completed, the diagnosis request transfer unit 30 notifies the transfer control unit 36 of the completion of the transfer of the diagnosis request. In this processing, the diagnosis request transfer unit 30 notifies the transfer control unit 36 that the transfer of the diagnosis request to the ECU1 has been completed.

In step S54, the transfer control unit 36 instructs the information management unit 24 to update the information indicating the progress state of the diagnosis.

In step S56, the information management unit 24 updates the information indicating the progress state of the diagnosis, and notifies the transfer control unit 36 of the updated information. In this processing, the information management unit 24 updates the progress state of the diagnosis in the ECU1 to a “diagnosis response reception standby state”.

In step S58, the diagnosis response reception unit 32 receives the diagnosis response from some ECUs 18 to which the diagnosis request has been transferred. In step S58, the diagnosis response reception unit 32 receives the diagnosis response from the ECU 1 to which the diagnosis request has been transferred.

In step S60, the diagnosis response reception unit 32 notifies the transfer control unit 36 of the reception of the diagnosis response.

In step S62, the transfer control unit 36 instructs the diagnosis response transfer unit 34 to transfer the diagnosis response to the external diagnostic equipment 10.

In step S64, the diagnosis response transfer unit 34 transfers the diagnosis response instructed by the transfer control unit 36 to the external diagnostic equipment 10. In this processing, the diagnosis response transfer unit 34 transfers the diagnosis response from the ECU1 to the external diagnostic equipment 10.

In step S66, when the transfer of the diagnosis response is completed, the diagnosis response transfer unit 34 notifies the transfer control unit 36 of the completion of the transfer of the diagnosis response. In this processing, the diagnosis response transfer unit 34 notifies the transfer control unit 36 of the completion of the transfer of the diagnosis response from the ECU1.

In step S68, the transfer control unit 36 instructs the information management unit 24 to update the information indicating the progress state of the diagnosis.

In step S70, the information management unit 24 updates the information indicating the progress state of the diagnosis, and notifies the transfer control unit 36 of the updated information. In this processing, the information management unit 24 updates the progress state of the diagnosis in the ECU1 to a “diagnosis response transfer completion state”.

In step S72, the transfer control unit 36 instructs the diagnosis request transfer unit 30 to transfer the diagnosis request to other ECUs 18 that have not transferred the diagnosis request among the plurality of ECUs 18. In this processing, the transfer control unit 36 instructs the diagnosis request transfer unit 30 to transfer the diagnosis request to the ECU 2.

In step S74, the diagnosis request transfer unit 30 transfers the diagnosis request to the ECUs 18 that are instructed by the transfer control unit 36. In this processing, the diagnosis request transfer unit 30 transfers the diagnosis request to the ECU 2.

In steps S76 to S94, the transfer device 20 performs, in the same manner as steps S52 to S70, processing relating to the transfer of the diagnosis request to the ECU 2 and processing relating to the transfer of the diagnosis response from the ECU2.

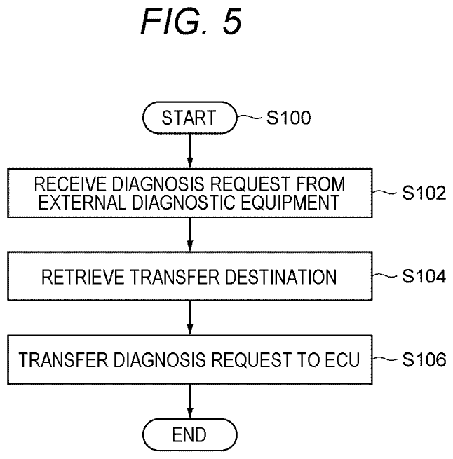

FIG. 5 is a flowchart illustrating processing performed by the transfer device 20 when the transfer device 20 receives a diagnosis request from the external diagnostic equipment 10.

Step S100 indicates a stage before the processing in steps S102 to S106 illustrated in FIG. 5 starts. In step S100, the state of the transfer device 20 is a standby state waiting for a diagnosis request from the external diagnostic equipment 10. The progress state of the diagnosis that is managed by the information management unit 24 may be set to a “diagnosis request reception standby state” with respect to all ECUs 18 that can be targets to be diagnosed.

In step S102, when the transfer device 20 receives the Ethernet frame, the transfer device 20 analyzes the protocol of the Ethernet frame and determines whether or not the Ethernet frame is a frame indicating a diagnosis request from the external diagnostic equipment 10 that conforms to DoIP. In a case where the received Ethernet frame indicates the diagnosis request, the transfer device 20 stores a message stored in the Ethernet frame in the storage area 22. In this manner, the transfer device 20 can receive the diagnosis request transmitted from the external diagnostic equipment 10 and store the diagnosis request in the storage area 22.

In step S104, the transfer device 20 retrieves transfer destinations in order to transfer the diagnosis request only to the ECUs18 that are designated in the diagnosis request. As a method of retrieving the transfer destinations, the following method is named. In the method, a table in which identifiers that are included in a diagnosis request, physical addresses of the ECUs18 of the transfer destinations, and information on busses of transfer destinations are associated with each other is stored in advance, and the transfer destination retrieval unit 26 retrieves the transfer destinations using this table. However, the method of retrieving the transfer destinations is not limited to the method that uses such a table. After the retrieval is completed, the transfer device 20 updates the progress state of the diagnosis managed by the information management unit 24 as follows. That is, the transfer device 20 updates the progress state of the diagnosis in the ECU 18 of the transfer destination to the “diagnosis request transfer standby state”.

In step S106, the transfer device 20 transfers the diagnosis request to the ECU 18 of the transfer destination. In this processing, there is a case where it is necessary for the transfer device 20 to transfer the diagnosis request to the plurality of ECUs 18. This is because, although an identifier that is included in the diagnosis request received in step S102 is a functional address, or the identifier is a physical address, the transfer device 20 receives a plurality of diagnosis requests. In this case, when the transfer device 20 transfers the diagnosis requests to the plurality of ECUs 18 simultaneously, the transfer device 20 can simultaneously receive the diagnosis response from each of the plurality of ECUs 18. Accordingly, it is necessary to secure a buffer area that covers the number of ECUs 18 that are targets to be diagnosed. However, to secure the buffer area that covers the number of ECUs 18 that are targets to be diagnosed, a memory use amount of the transfer device 20 is increased and hence, there is a possibility that the memory resource becomes short.

According to the transfer device 20 of the present embodiment, even when the transfer device 20 receives the diagnosis request with respect to the plurality of ECUs 18 in step S102, the transfer device 20 transfers the diagnosis request to some ECUs 18 out of the plurality of ECUs 18 in step S106. In this processing, it is assumed that the transfer device 20 transfers the diagnosis request to one ECU 18.

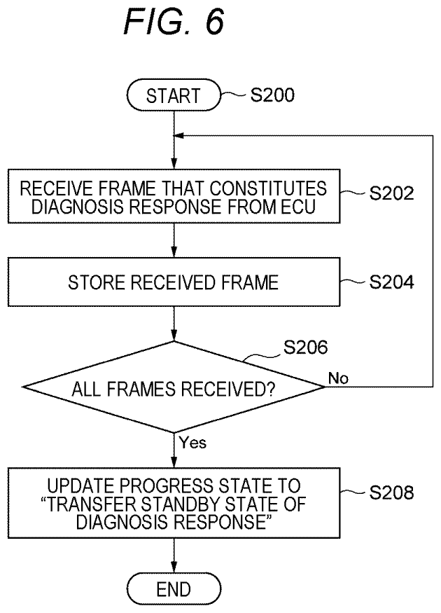

As a method of transferring the diagnosis request to one ECU 18, there is a method of designating a physical address allocated to each ECU18 as a transfer destination. After the transfer of the diagnosis request is completed, the transfer device 20 updates the progress state of the diagnosis that is managed by the information management unit 24 as follows. That is, the transfer device 20 updates the progress state of the diagnosis in the ECU 18 that is the transfer destination to a “diagnosis response reception standby state”. After such updating is completed, the transfer device 20 ends the processing illustrated in FIG. 5 and performs the processing illustrated in FIG. 6.

When there is a margin in the memory resource of the transfer device 20, the transfer device 20 may transfer a diagnosis request to two or more ECUs 18 in step S106 instead of transferring the diagnosis request to one ECU18 in step S106. However, the number of ECUs 18 to which the diagnosis request is transferred in step S106 is set smaller than the number of ECUs 18 designated based on the diagnosis request when the transfer device 20 receives the diagnosis request with respect to the plurality of ECUs 18 in step S102.

When the transfer device 20 transfers the diagnosis request to the ECUs18 in step S106, the transfer device 20 sequentially transfers the diagnosis request to the ECUs18 in accordance with a priority order determined in advance with respect to the respective targets ECUs 18 to be diagnosed. The method of determining the priority order is not particularly limited. The priority order may be determined, for example, similarly to the priority order in the communication arbitration performed in accordance with a communication protocol of the in-vehicle network 3. In a case where the communication protocol of the in-vehicle network 3 is CAN, the priority order in the communication arbitration is determined using a CANID (identifier) or an RTR. Also with respect to the priority order at the time of transferring the diagnosis request to the ECUs 18 in step S106, such priority order may be determined substantially in the same manner as the priority order in the communication arbitration using the CANID or the RTR.

FIG. 6 is a flowchart illustrating processing performed by the transfer device 20 when the transfer device 20 receives a diagnosis response from the ECU 18.

Step S200 indicates a stage before the processing in steps S202 to S208 illustrated in FIG. 6 is started. In step S200, the state of the transfer device 20 is a state where the transfer device 20 waits for a diagnosis response from the ECU 18 to which the diagnosis request has been transferred.

The size of the diagnosis response may exceed the size of a frame prescribed in a communication protocol of the in-vehicle network 3. In this case, the ECU18 to which the diagnosis request is transferred divides one diagnosis response into a plurality of frames and transmits the frames to the transfer device 20.

In step S202, the transfer device 20 receives the frames that constitute the diagnosis response from the ECU 18.

In step S204, the transfer device 20 stores the received frames in the storage area 22.

In step S206, the transfer device 20 determines whether or not the transfer device 20 has received all the frames constituting one diagnosis response. In a case where the communication protocol of in-vehicle network 3 is CAN, in transmitting the diagnosis response by dividing the diagnosis response into a plurality of CAN frames, the ECU 18 transmits the diagnosis response in a state where a total size of the plurality of CAN frames that constitute one diagnosis response is stored in the head CAN frame. By making use of the information on the total size, the transfer device 20 can determine whether or not the transfer device 20 has received all frames that constitute one diagnosis response. In a case where the transfer device 20 has received all frames, the processing advances to step S208. In a case where the transfer device 20 has not received all frames, the processing returns to step S202.

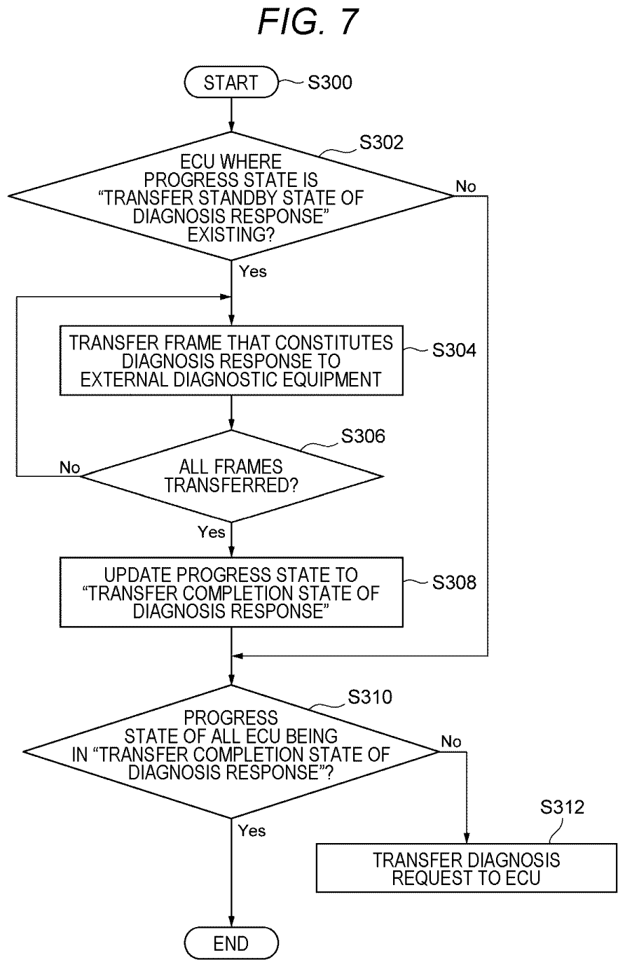

In step S208, the transfer device 20 updates the progress state of the diagnosis managed by the information management unit 24 as follows. That is, the transfer device 20 updates the progress state of the diagnosis in the ECU 18 that is the transmission source of the diagnosis response to the “diagnosis response transfer standby state”. After such updating is completed, the transfer device 20 finishes the processing illustrated in FIG. 6 and performs the processing illustrated in FIG. 7.

FIG. 7 is a flowchart illustrating processing performed by the transfer device when the transfer device 20 transfers the diagnosis response to the external diagnostic equipment 10.

Step S300 indicates a stage before the processing in steps S302 to S312 illustrated in FIG. 7 is started. In step S300, the state of the transfer device 20 is a state before the transfer device 20 transfers a diagnosis response from the ECU 18 that is a target to be diagnosed to the external diagnostic equipment 10.

In step S302, the transfer device 20 determines whether or not there is an ECU 18 whose progress state of the diagnosis managed by the information management unit 24 is a “diagnosis response transfer standby state”. In a case where the ECU 18 that is in a “diagnosis response transfer standby state” exists, the transfer device 20 advances to step S304. In a case where the ECU 18 that is in a “diagnosis response transfer standby state” does not exist, the transfer device 20 advances to step S310.

In step S304, the transfer device 20 transfers a frame that constitutes a diagnosis response to the external diagnostic equipment 10. In transferring the diagnosis response to the external diagnostic equipment 10, the transfer device 20 generates an Ethernet frame that includes a diagnosis response in accordance with DoIP and transfers the Ethernet frame to the external diagnostic equipment 10.

In step S306, it is determined whether or not the transfer device 20 has transferred all frames that constitute one diagnosis response to the external diagnostic equipment 10. In a case where the transfer device 20 has transferred all frames, the processing advances to step S308. In a case where the transfer device 20 has not transferred all frames, the processing returns to step S304.

In step S308, the transfer device 20 updates the progress state of the diagnosis managed by the information management unit 24 as follows. That is, the transfer device 20 updates the progress state of the diagnosis in the ECU 18 that has transferred the diagnosis response to a “diagnosis response transfer completion state”. After the updating of the progress state of the diagnosis is completed, the processing performed by the transfer device 20 advances to step S310.

In step S310, the transfer device 20 determines whether or not the progress state of the diagnosis in all ECUs 18 designated in the diagnosis request that the transfer device 20 has received in step S102 is the “diagnosis response transfer completion state”. In a case where the progress state of the diagnosis in all ECUs 18 is the “diagnosis response transfer completion state”, the transfer device 20 finishes the processing illustrated in FIG. 7. In a case where the progress state of the diagnosis in all ECUs 18 is not the “diagnosis response transfer completion state”, the transfer device 20 advances to step S312.

In step S312, the transfer device 20 transfers the diagnosis request to the ECUs 18 to which the diagnosis request has not been transferred out of the plurality of ECUs 18 that are designated in the diagnosis request received in step S102. Specific contents of the processing are substantially equal to the contents of the processing in step S106.

As has been described above, the transfer device 20 of the present embodiment receives a diagnosis request that is a message from the external diagnostic equipment 10 to the plurality of ECUs 18, from the external diagnostic equipment 10, and transfers the diagnosis request to some of the plurality of ECUs 18. In such processing, the transfer device 20 can sequentially transfer the diagnosis request in accordance with a priority order determined in advance with respect to the respective ECUs 18 that are targets to be diagnosed. Then, the transfer device 20 receives a diagnosis response that is a message from the ECU18 to the external diagnostic equipment 10 from some ECUs 18, transfers the diagnosis response to the external diagnostic equipment 10 and, thereafter, transfers the diagnosis request to ECUs 18 different from the above-mentioned some ECUs 18.

With such processing, the transfer device 20 of the present embodiment can set the number of diagnosis responses that can be received from the ECUs 18 simultaneously smaller than the number of ECUs 18 that can be targets to be diagnosed. It is unnecessary for the transfer device 20 to secure a buffer area that can cover the number of ECUs 18 that can be targets to be diagnosed and hence, and a memory use amount can be suppressed compared to the prior art. According to the present embodiment, it is possible to provide the transfer device 20 capable of suppressing shortage of a memory resource even when the transfer device 20 receives a diagnosis request with respect to a plurality of electronic devices ECU 18 from the external diagnostic equipment 10.

Further, the transfer device 20 of the present embodiment transfers the diagnosis response from some of the ECUs 18 to the external diagnostic equipment 10 and, thereafter, receives the diagnosis response from the other ECUs18.

Accordingly, there is no possibility that the transfer device 20 of the present embodiment simultaneously receives both the diagnosis response from some ECUs 18 and the diagnosis response from other ECUs 18. It is unnecessary for the transfer device 20 to secure a buffer area for simultaneously storing the diagnosis response from some ECUs 18 and the diagnosis response from other ECUs 18 and hence, a memory use amount can be further suppressed. According to the present embodiment, it is possible to provide the transfer device 20 capable of suppressing shortage of a memory resource even when the transfer device 20 receives a diagnosis request with respect to a plurality of electronic devices ECU 18 from the external diagnostic equipment 10.

Further, the ECU18 of the present embodiment divides the diagnosis response into a plurality of frames and transmits the frames to the transfer device 20. The transfer device 20 of the present embodiment, after receiving all frames that constitute the diagnosis response from the ECU18, transfers all frames to the external diagnostic equipment 10.

Accordingly, the transfer device 20 of the present embodiment can continuously transfer all frames that constitute the diagnosis response to the external diagnostic equipment 10. There is no possibility that one frames that constitute a certain diagnosis response and the other frames that constitute another diagnosis response are transferred to the external diagnostic equipment 10 in a mixed manner in random order. Accordingly, the transfer device 20 of the present embodiment can prevent the occurrence of a situation where the external diagnostic equipment 10 cannot identify the ECUs 18 that are the transmission source of the frames to be transferred. Accordingly, according to the present embodiment, it is possible to provide the transfer device 20 capable of reliably realizing a message transfer function with certainty between the external diagnostic equipment 10 and the plurality of ECUs 18.

Further, the transfer device 20 of the present embodiment transfers all frames that constitute the diagnosis response from some ECUs 18 to the external diagnostic equipment 10 and, thereafter, transfers the diagnosis request to other ECUs 18.

Accordingly, it is unnecessary for the transfer device 20 of the present embodiment to secure a buffer area for simultaneously storing the diagnosis response from some ECUs 18 and the diagnosis response from other ECUs 18 and hence, a memory use amount can be further suppressed. In addition, in the transfer device 20 of the present embodiment, since frames from some ECUs 18 and frames from other ECUs 18 are not transferred in a mixed manner in random order, it is possible to prevent occurrence of a situation in which the external diagnostic equipment 10 cannot identify the ECU18 that is the transmission source of the frame. According to the present embodiment, it is possible to provide the transfer device 20 capable of suppressing shortage of a memory resource and, at the same time, can realize a message transfer function with certainty.

Further, the transfer device 20 of the present embodiment, in transferring the diagnosis request to some ECUs 18, sequentially transfers the diagnosis request in accordance with a priority order that is determined in advance for each ECU18.

Accordingly, the transfer device 20 of the present embodiment can sequentially receive the diagnosis response from the ECUs 18 and hence, it is unnecessary for the transfer device 20 of the present embodiment to secure a buffer area for simultaneously storing the diagnosis response from the plurality of ECUs 18 and hence, a memory use amount can be further suppressed. According to the present embodiment, it is possible to provide the transfer device 20 capable of suppressing shortage of a memory resource even when the transfer device 20 receives a diagnosis request with respect to a plurality of electronic devices ECU 18 from the external diagnostic equipment 10.

### Other Technical Features

The present invention is not limited to the above-mentioned embodiments, and includes various modifications. For example, the above-mentioned embodiments have been described in detail to facilitate the understanding of the present invention, and are not necessarily limited to those embodiments having all the described configurations. Further, a part of the configuration of one embodiment can be replaced with the configuration of another embodiment, and the configuration of another embodiment can be added to the configuration of one embodiment. In addition, it is possible to add, delete, and replace other configurations with respect to a part of the configuration of each embodiment.

In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function. Information such as a program, a tape, and a file for realizing each function can be stored in a recording device such as a memory, a hard disk, and a solid state drive (SSD), or a recording medium such as an IC card, an SD card, and a DVD.

In addition, the control lines and the information lines indicate that are considered to be necessary for the description, and do not necessarily indicate all the control lines and the information lines on the product. In practice, it may be considered that almost all the configurations are connected to each other.

### REFERENCE SIGNS LIST

10 external diagnostic equipment
18 ECU (electronic device)
20 transfer device

1. A transfer device that transfers a message from one side to another side between a plurality of electronic devices mounted on a vehicle and an external diagnostic equipment, wherein the transfer device is configured such that:
the transfer device receives a diagnosis request that is a message from the external diagnostic equipment to the plurality of electronic devices, and transfers the diagnosis request to some electronic devices out of the plurality of electronic devices; and
the transfer device receives a diagnosis response that is a message from the electronic devices to the external diagnostic equipment from the some electronic devices and transfers the diagnosis response to the external diagnostic device and, thereafter, transfers the diagnosis request to another electronic devices different from the some electronic devices.

2. The transfer device according to claim 1, wherein
the transfer device is configured to receive the diagnosis response from the another electronic devices after the transfer device transfers the diagnosis response from the some electronic devices to the external diagnostic equipment.

3. The transfer device according to claim 1, wherein
the electronic device divides the diagnosis response into a plurality of frames and transmits the frames to the transfer device, and
the transfer device receives all frames that constitute the diagnosis response from the electronic device and, thereafter, transfers all frames to the external diagnostic equipment.

4. The transfer device according to claim 3, wherein
the transfer device transfers the all frames to the external diagnostic equipment and, thereafter, transfers the diagnosis request to the another electronic devices.

5. The transfer device according to claim 1, wherein,
the transfer device, in transferring the diagnosis request to the some electronic devices, transfers the diagnosis request sequentially in accordance with a priority order that is determined in advance for each of the electronic devices.
